(19) United States
(12) Patent Application Publication
(10) Pub. No.: US 2016/0103053 A1
(43) Pub. Date: Apr. 14, 2016

(54) METHOD AND DEVICE FOR DETERMINING THE FILLING QUALITY OF A FREQUENCY OSCILLATOR

(71) Applicant: ANTON PAAR GMBH, GRAZ-STRASSGANG (AT)

(72) Inventors: WOLFGANG BELITSCH, HART BEI GRAZ (AT); STEFAN ROSSEGGER, GRAZ (AT); ROBERT AMSUESS, GRAZ (AT)

(21) Appl. No.: 14/881,324

(22) Filed: Oct. 13, 2015

(30) Foreign Application Priority Data
Oct. 10, 2014 (AT) A50726/2014

(51) Int. Cl. G01N 11/04

(52) U.S. Cl. CPC G01N 11/04; G01N 2011/0006

(57) ABSTRACT

A method determines the filling quality of a frequency oscillator where a measured fluid is passed through an oscillator tube. The relationship between the viscosity-dependent density of the measured fluid and the quality and/or attenuation of the oscillator tube is determined. The relationship between the dynamic viscosity and the attenuation and/or quality of the measured fluid is determined, and these values are used to create a calibration table that reproduces the functional relationship between a parameter relevant for the quality and/or the attenuation of the frequency oscillator and the viscosity of the measured fluid. An independent measuring apparatus determines a measured value for the dynamic viscosity of the measured fluid. The obtained measurement value for the viscosity coincides in the calibration table with a specific function value, and the result of this comparison with respect to the presence of any filling errors is used to determine a possible filling error.

### CROSS-REFERENCE TO RELATED APPLICATION

This application claims the priority, under 35 U.S.C. §119, of Austrian application No. A 50726/2014, filed Oct. 10, 2014; the prior application is herewith incorporated by reference in its entirety.

### BACKGROUND OF THE INVENTION

### Field of the Invention

The invention relates to a method for determining the filling quality of a frequency oscillator, where the measured fluid flows through the oscillator tube, and a device for carrying out the method.

Austrian patent AT 505 937, corresponding to U.S. Pat. No. 7,945,395, shows a method for detecting filling errors based on the oscillation behavior in fundamental and harmonic waves. A “bubble free curve” for the correct filling is determined from the oscillation behavior by calibration measurements, and then a band for the maximum deviation of the measured values in fundamental and harmonic waves is defined to determine the correct filling of a frequency oscillator.

### SUMMARY OF THE INVENTION

The primary objective of the invention is the detection of gas bubbles during the filling of a frequency oscillator, wherein the gas bubbles are located in the fluid samples to be measured and which would result in a false reading. The fact that gas bubbles contained in the fluid sample not only cause a change in the resonance frequency but also cause a change in the quality of the oscillation system is used to this end.

The measurement of the density of fluid media with a frequency oscillator is based on the fact that the vibration of a hollow body filled with a sample to be examined is dependent on the filling of the oscillator tube, i.e. on the mass or, when the volume is constant, from the density of the filled medium.

A measuring cell contains the oscillatory structure, i.e. a hollow U-shaped, glass or metallic tube body. This is excited to a non-attenuated oscillation by electronic means. The two legs of the U-shaped tube form the spring elements of the oscillator. The natural frequency of the U-shaped oscillator tube is influenced only by that portion of the sample that is actually involved in the oscillation. The volume V involved in the oscillation is limited by the quiescent oscillation nodes at the clamping points of the oscillator tube. If the oscillator tube is filled at least up to the clamping points with the sample, then the same precisely defined volume V is always involved in the oscillation and the mass of the sample can therefore be assumed to be proportional to its density. Overfilling of the vibrator above the clamping points is irrelevant for the measurement. For this reason, the density of fluids flowing through the oscillator can be measured with the oscillator.

For example, the excitation of the legs of the U-shaped tube can be carried out against one another. This results in certain resonance frequencies in the oscillator, at which the system preferably oscillates.

The density of the fluid thus determines the specific frequencies at which the U-shaped tube oscillates. If one uses precision glass or metal tubes, then the harmonic characteristics vary as a function of the density and viscosity of the fluid. The resonant frequencies are evaluated by appropriate stimulation and pick-up of the oscillations, while the density of the filled fluid sample is determined from the period duration. The oscillator is calibrated with fluids of known density thus enabling the measurements to be evaluated.

Such density oscillators or frequency oscillators have long been known and are produced in many different embodiments with respect to excitation and picking up the oscillation, (for example with magnetic coils and magnets, piezoelectric elements, capacitive measurement . . . ).

Other features which are considered as characteristic for the invention are set forth in the appended claims.

Although the invention is illustrated and described herein as embodied in a method and a device for determining the filling quality of a frequency oscillator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a frequency oscillator;

FIG. 2 is a graph showing a course of a measurement error of the frequency oscillator due to the viscosity;

FIG. 3 is an illustration showing a rotational viscosity meter;

FIG. 4 is a graph showing quality factor curves for various frequencies of an oscillator as Q=f(η);

FIG. 5 is a graph showing measured values lying inside and outside a tolerance band and enables one to decide whether filling errors are present via the z-result (multiples of the standard deviation G);

FIG. 6 is a graph plotting the δ ρ to ρ error as a function of the quality which results in a parabolic relationship; and

FIG. 7 is a graph showing how an incorrect measurement of the viscosity can be identified by an inverse method.

### DETAILED DESCRIPTION OF THE INVENTION

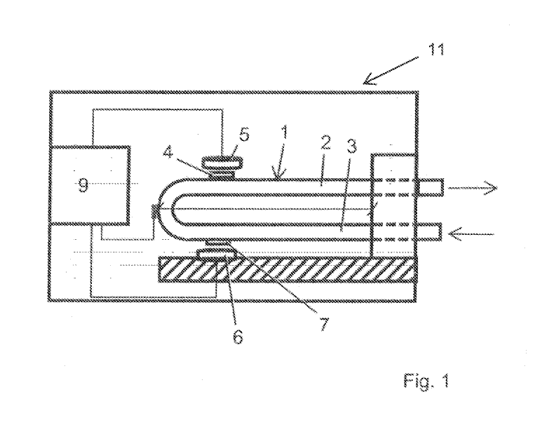

Referring now to the figures of the drawings in detail and first, particularly to FIG. 1 thereof, there is shown schematically a frequency oscillator 11.

In this case, an oscillation is generated by a magnet 7 directly on an oscillator tube 3, which interacts with an opposing coil 6. A second combination of coil 5 and magnet 4 is mounted on the other leg 2 of the U-shaped tube to pick-up the formed oscillation. Furthermore, reference number 9 identifies an evaluation unit.

The excitation and pick-up can also be effected by piezo elements, for example, the elements are so positioned that they do not lie at a nodal point of the natural oscillations of the oscillator being examined, but can also be carried out, for example, close to the clamping points.

The excitation of the oscillator to oscillate is effected, for example, by a digital excitation amplifier, which is controlled in a control loop by the pick-up signal e.g. adjusted to the maximum amplitude and thus to the natural oscillation of the frequency oscillator. The control and evaluation electronics measure the signals, e.g. amplitude, frequency and phase angle between the excitation and pick-up signals or another parameter representative of the quality of the oscillator and thus the attenuation of the system.

The characteristic frequency of the oscillator depends on the material of the oscillator tube 1 and its geometry, in particular the diameter of the U-shaped tube 1, the length of the legs 2, 3, the bending radius and thus also the distance of the two legs 2, 3 from one another

In order to calculate the density from the oscillation period, a hollow body of mass m is observed at a certain temperature, wherein it is resiliently suspended on a spring with a spring rate R. Its volume V is filled with a fluid of density p.

The fundamental frequency for the period P of this system is:

$$P = 2 π \sqrt{\frac{( m + ρ V )}{R}} \qquad ( 1 )$$

resulting in the density through transformation:

$$ρ = {P}^{z} \frac{R}{4 {π}^{2} V} - \frac{m}{V} = A {P}^{z} - B \qquad ( 2 )$$

with the calibration constants A and B. These include the spring rate R of the oscillator, the mass and the volume of the fluid involved in the oscillation. A and B are thus apparatus constants or calibration values of an individual oscillator. They can be determined from two measurements of the oscillation period of the oscillator, filled with fluids of known different densities, normally air and water, or special calibration. The behavior of the oscillator and thus also the constants A and B, however, are viscosity-dependent. Thus, as a rule, the above-determined density values can or must be provided with a viscosity correction.

It is known that the attenuation of the frequency oscillator is influenced mainly by the viscosity and the homogeneity of the sample. With the proviso that there are no filling errors, then, with proper construction and dimensioning of the oscillator, a unique functional relationship between the viscosity and quality of a resonant oscillation can be found.

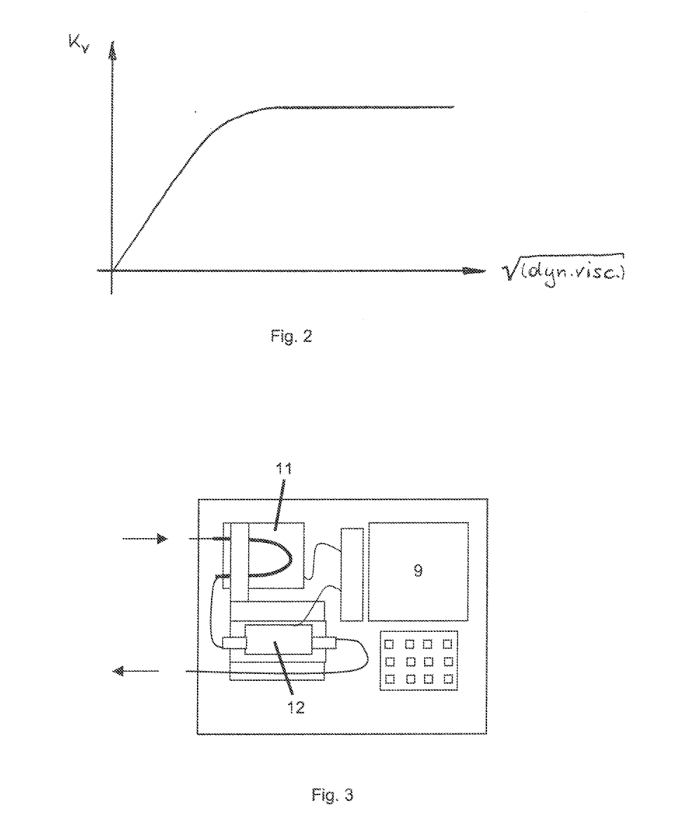

The influence of the dynamic viscosity (η) for the viscosity-dependent density measurement error (Kᵥ (η)=Δ ρ(η)/ρ) in the measurement of the density of the test sample fluid is also known and shown in FIG. 2. FIG. 2 shows the course of the measurement error of the frequency oscillator due to the viscosity.

In commercially available frequency oscillators, this dependency is used for the viscosity correction of the density measured value (see e.g. Austrian Patent AT 400 767 B, European Patent EP 0 487 499 A2, U.S. Pat. No. 5,339,258). All of these corrections are based on the relationship between the quality of the oscillator and the viscosity of the measured fluid in the oscillator.

The quality factor (quality factor Q) is often used as a measure of the attenuation, wherein, by definition, it can be determined for a resonant oscillation at a resonant frequency fᵣₑₛ and associated half-width of the resonance curve Δf_{FWHM} of the oscillator through Q=fᵣₑₛ/Δf_{FWHM}. The quality factor is thus a measure for the attenuation of the oscillator and is indirectly proportional to this.

Not only density meters, but also other measuring devices or sensors such as sonic velocity measuring devices or viscosity meters are frequently used for advanced characterization of samples.

For combined measurements with various sensors, the measurement results of a sensor can be provided, for example, via an interface to the second sensor or its evaluation unit. Moreover, the sensors can be operated with a single evaluation and display unit. The calculation unit then directly provides the measured values of both sensors.

For example, a rotary viscosity meter for determining the dynamic viscosity of a fluid sample is known in which the sample is e.g. first fed to a frequency oscillator 11 for the density measurement, and then to a viscosity meter 12. A common evaluation and display unit 9 processes the signals from the oscillator and viscosity sensor and displays both the viscosity and density of the examined fluid.

FIG. 3 shows such a rotational viscosity meter schematically.

The frequency oscillator 11 shown in FIG. 3 can also be used in combination with other sensors such as rotational viscosity meters or sensors that determine the viscosity from the vibration of membranes (MEMS).

According to the invention, a method of the aforementioned type is characterised by the features specified in the characterising part of main method patent claim. It is provided that the relationship between the viscosity-dependent density of the measured fluid and the quality and/or attenuation of the oscillator tube, preferably amplitude and/or phase of a natural oscillation, is determined. The relationship between the dynamic viscosity and the attenuation and/or quality of the measured fluid is determined. These values are used to create a calibration curve or table that reproduces the functional relationship between a parameter relevant for the quality and/or the attenuation of the frequency oscillator and the viscosity of the measured fluid. In the course of measurement of the measured fluid with the frequency oscillator, an independent, further or additional measuring apparatus determines at least a measured value for the dynamic viscosity of the measured fluid. In the course of measurement of the measured fluid with the frequency oscillator, at least a measurement value for the relevant parameter, preferably the density of the measured fluid, is determined. The obtained measurement value for the viscosity coincides on the calibration curve or in the calibration table with a specific or determined function value having the function value, which is specified or determined by the obtained measurement value for the quality and/or attenuation on the calibration curve or calibration table. The result of this comparison with respect to the presence of any filling errors is evaluated, or used to determine a possible filling error of the frequency oscillator.

A device according to the invention is characterized in that the device contains a measuring unit in the form of a frequency oscillator 11, which determines the viscosity-dependent density value of the measured fluid flowing through the oscillator tube. The device additionally contains a unit for determining the values of the dynamic viscosity of the measurement fluid. These two measurement units are connected to an evaluation unit which determines this viscosity dependent density value from the quality and/or attenuation of the oscillator tube of the frequency oscillator. The evaluation unit includes an calibration curve or table, wherein the calibration curve or table contains or reproduces the previously determined functional relationship between one of the parameters relevant for quality or attenuation of the frequency oscillator and the dynamic viscosity of the measured fluid.

In this way, the frequency oscillator can be provided with a value for the dynamic viscosity of the filled fluid to examine the filling quality, wherein the filling quality of the frequency oscillator or the system is examined with the viscosity value known from the measurement of the fluid to be tested.

The method is based on the effect that the attenuation is primarily influenced by the viscosity and the homogeneity of the sample. With the proviso that there are no filling errors and with proper construction and dimensioning of the oscillator, a unique functional relationship between the viscosity and the quality can be found.

Thus, with a known reference viscosity of the sample, any deviation from the expected quality, which is directly proportional to the probability of filling errors, can be detected.

The detection of filling errors then takes place in several steps.

First, a calibration curve is at least displayed in an evaluation unit to present a characteristic of the quality and/or attenuation of the frequency oscillator measurement in a functional relationship with the dynamic viscosity of the fluid, for example, dependence on the square root of the quality of the dynamic viscosity. The calibration curve can be determined by standards of known viscosity and/or density, or calculated for the linear ranges for an oscillator through simulation; alternatively, a table of values may be simply stored.

Second, a separately working, external, further measurement unit is used to determine the viscosity value of the fluid to be examined, and this is provided to detect the filling quality of the oscillator of the evaluation unit of the frequency oscillator or the common evaluation unit.

Third, at least one of the attenuation characteristic parameters of the test fluid is measured, wherein the fluid to be examined is examined with the frequency oscillator.

Fourth, from the comparison of the measured value, which is representative of the quality/attenuation of the oscillator, with the measured value, which is determined in the density measurement using the frequency oscillator, one can assess the extent to which a bubble-free or inhomogeneity-free filling of the oscillator is present.

Fifth, a maximum allowable deviation for a given accuracy of the actual measurement of the density measurement for comparing the two values may be specified or provided. Optionally, a warning can be issued on deviation of the measured value from the expected value and the user is prompted to fill the measuring system.

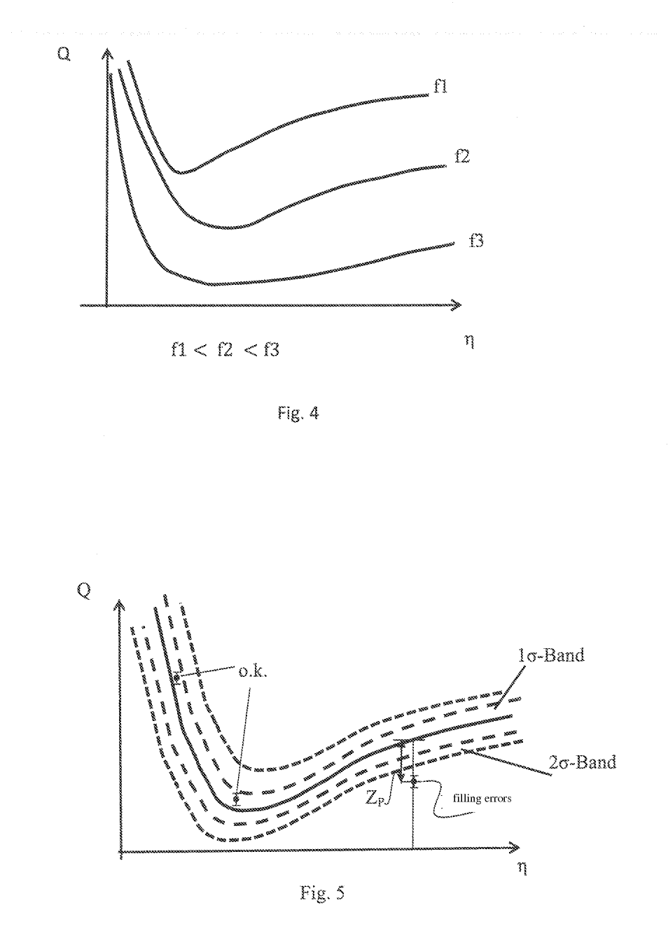

Initially, in a first calibration step, the dependence of the quality, or a quantity derived from it, is determined from the density and viscosity using samples with known values or calibration standards. This dependence is presented as a function and stored, as shown in FIG. 4. This dependence can also be stored as a table of values or calibration table in the evaluation unit.

Each oscillator can thus be provided with a calibration function that represents the relationship between a parameter representing the quality/attenuation of the oscillator and the viscosity.

The measurement of the quality of the fundamental frequency or harmonic of the oscillator can be carried out in a known manner in various ways, such as phase rotation, decay measurement, amplitude measurement, amplitude modulation, bandwidth measurement of the resonance, or period measurement in two different natural frequencies of the oscillation system.

This calibration function is provided in the evaluation unit of the inventive device. With an evaluation unit equipped in this way, the measurement is effected and a measured value for the quality and a measured value for the viscosity are determined, and the distance, possibly a distance measurement, is determined from these two measured value to become values on the calibration curve or contained in the calibration table. Examples of calibration curves for different resonance frequencies are shown in FIG. 4.

Further steps can at least take place in different ways.

For example, as shown in FIG. 5, a tolerance band can be specified through multiple measurements, within which the measured values must lie for the attenuation and/or quality of an unknown sample fluid to be measured and for a predetermined or measured viscosity.

Calibration measurements for a plurality of samples reveal an error or error interval for each measurement point of the calibration curve or table. The measured value arising from the measurement of the unknown sample fluid is checked to ensure it is within the defined tolerance band. If this measured value is outside the band, then this indicates that the filling quality of the oscillator is outside the defined range.

A particularly preferred embodiment of this approach proposes to use the purely statistical z-value for checking this tolerance band.

The z-value allows one to take a sample value from a sample and calculate how many standard deviations there are above or below the mean. For this purpose, one also determines the standard deviation of the individual measurement points on creation of the calibration curve. The z-value is calculated from the actual measured value of Q or the parameter P representing the quality/attenuation of the oscillator as a function of the viscosity n and selected to produce the calibration function, wherein the function value of the determined or calculated Q is a function of the viscosity and describes the deviation of a measured value as a multiple of the standard deviation.

Compared to known methods of bubble detection, the proposed approach is very simple and less prone to error because it reduces the required decision parameters to one, i.e. the reference viscosity.

FIG. 4 shows an example of the quality factor curves for various frequencies of the oscillator as Q=f(η).

FIG. 5 shows measured values lying inside and outside the tolerance band and enables one to decide whether filling errors are present via the z-result (multiples of the standard deviation G).

Depending on the mode used and the required accuracy of the bubble detection, so the viscosity used, or the viscosity value used, as the measured value does not need to be known very accurately. In general, an error <10% for the determined viscosity value is sufficient. This viscosity can therefore be measured by simple measures. Furthermore, this approach accelerates the detection of bubbles, as it requires no further information and can already be used at the beginning of the density measurement. Online monitoring is possible.

This approach has the advantage that already during filling and without calculating a density value for a known viscosity, the measurement data can be used directly for checking the filling quality.

From the z-value, it can also be seen how well the oscillator tube is filled and immediate proof is received whether the z-value has the desired accuracy of the measurement. One can easily determine empirical limits here. Since the density measurement is often heavily influenced by tiny bubbles, one can define the limits of the desired accuracy of the density measurement.

1. A further evaluation option is that a calibration curve is obtained, such as illustrated in FIG. 2, where Kv=F(η) is determined with various density and viscosity standards.

This calibration function is a direct calibration function that sets the density of the error frequency oscillator in direct relationship with the viscosity.

2. A density correction value K_{d} is determined or calculated from the measurement of the attenuation or a derived variable. Here, then, not only is a parameter measured, but the parameters are translated into a further calibration curve in the function determined by 1).

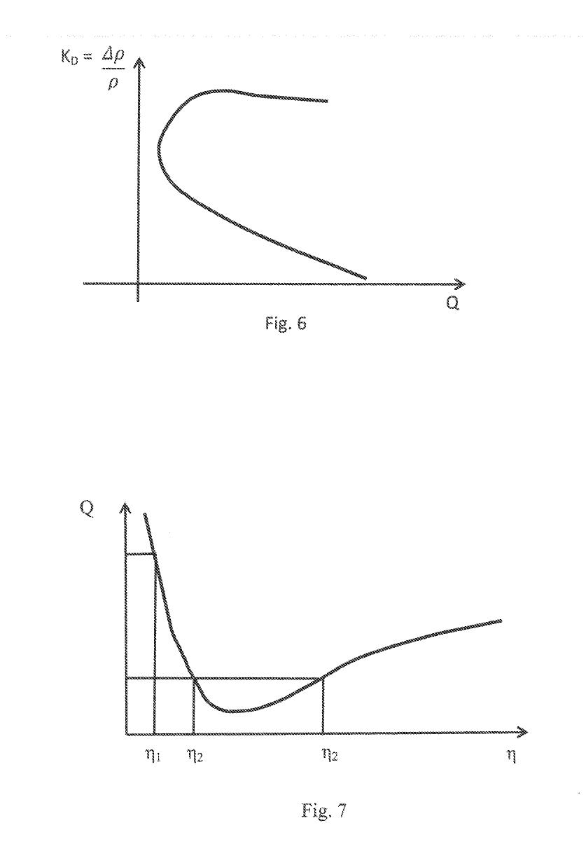

If one takes the δ ρ to ρ error as a function of the quality, one obtains a parabolic relationship that looks rather as shown in FIG. 6:

3. A density correction value Kᵥ is calculated from the measured value or determined with the viscosity meter from the calibration curve of the frequency oscillator used. (Calibration measurements with various viscosity standards)

4. The values of K_{d}, determined from the calibration function of the quality of a natural oscillation, and Kᵥ, are compared with one another. If they do not match within a predetermined limit, then a filling error warning is output. For example, it can be determined that the amount of the difference K_{d}−Kᵥ must not exceed a certain value, for example K_{d}−Kᵥ<0.0001.

It also ensures that the quality of the oscillator is correlated with the actual viscosity of the filled medium and does not distort inhomogeneities in the filling of the oscillator to the measured value.

Determination of filling quality in the SVM viscometer is now described.

Of course, the filling in the above-mentioned viscometer may be carried out poorly and the determined viscosity value might not correspond to the reality. In this case, the viscosity of the sample examined is faulty and there is a discrepancy in the second method proposed between the two correction values for the density, although the filling of the oscillator is carried out correctly.

This may, for example, be checked by determining the actual viscosity of the fluid from the quality of the oscillator via the calibration curve in the evaluation unit.

In addition, when combined with a viscosity measurement, the plausibility of the viscosity measurement can be tested. One possible significant filling error, or more generally, an incorrect measurement of the viscosity can be identified by means of the inverse method, (see FIG. 7).

For this purpose, a second harmonic or any other mode would have to be examined and measured as described in the above method. The viscosity can indeed be inferred from a quality based on the functional relationship. If the curve is not clear, then the proper viscosity value to be used can also be determined through the combination of two measurements. If the viscosity determined from the quality of the first examined natural oscillation is in agreement with that of a second examined mode, it can be assumed that the filling errors must be sought in the viscometer or an incorrectly measured viscosity value, and the frequency oscillator is filled correctly.

A combination of the method thus leads to reliable determination as to whether the difference lies in the viscosity measurement. If the quality of two different natural oscillations (for example, primary and first harmonic) is not identical, it is to be suspected that the filling errors lies in the density of the cell.

1. A method for determining a filling quality of a frequency oscillator, which comprises the steps of:
passing a measured fluid through an oscillator tube;
determining a relationship between a viscosity-dependent density of the measured fluid and a quality and/or an attenuation of the oscillator tube;
determining a relationship between a dynamic viscosity and the attenuation and/or the quality of the measured fluid;
using these values to create a calibration curve or calibration table that reproduces a functional relationship between a relevant parameter relevant to the quality and/or the attenuation of the frequency oscillator and the dynamic viscosity of the measured fluid;
determining at least a measured value for the dynamic viscosity of the measured fluid in a course of measurement of the measured fluid using the frequency oscillator with an independent or further additional meter;
during the course of measurement of the measured fluid with the frequency oscillator, determining at least a measured value for the relevant parameter, a function value required or determined through the measured value obtained for the dynamic viscosity on the calibration curve or in the calibration table matches a characteristic value which is required or determined through an obtained measurement value for the quality and/or the attenuation on the calibration curve or the calibration table; and
evaluating a result of a comparison with respect to a presence of any filling errors or is used to determine a possible filling error of the frequency oscillator.

2. The method according to claim 1, which further comprises carrying out a measurement of the dynamic viscosity and the quality independently, but with various or independent measuring devices.

3. The method according to claim 1, wherein based on the calibration curve or the calibration table, an extent to which determined function values deviate from those specified on the calibration curve or in the calibration table is checked, and, if appropriate, on exceeding a deviation, a presence of a filling error, including a presence of bubbles or in homogeneities in a sample fluid, are detected.

4. The method according to claim 1, which further comprises performing at least one of:
determining the calibration curve with standards of known viscosity and/or density;
calculating the relationship by simulation, or
providing a predetermined value table.

5. The method according to claim 1, which further comprises supplying the measured values for the dynamic viscosity and the quality and/or the attenuation to an evaluation unit connected with the frequency oscillator in which, if appropriate, the calibration curves and/or the calibration table is saved or stored.

6. The method according to claim 1, wherein the calibration curve or the calibration table is created or provided in a form of a predetermined functional relationship between viscosity values and quality values, attenuation values or density error values, such as a square root relationship.

7. The method according to claim 1, which further comprises using values for a fundamental oscillation and/or at least a harmonic to determine the quality and/or the attenuation of the frequency oscillator.

8. The method according to claim 1, which further comprises determining a tolerance band for values on the calibration curve or in the calibration table through multiple measurements, and it is checked whether the values functionally assigned to the measured values for the attenuation and/or the quality and/or viscosity values of the measured fluid lie within a tolerance band and are detected when necessary on proper filling.

9. The method according to claim 1, which further comprises:
making calibration measurements concerning density and/or viscosity according to a variety of standards and thus an error interval is set for each functional value of the calibration curve or any value of the calibration table; and
checking a value resulting from the measurement of the measured fluid to determine whether it lies within a defined tolerance band.

10. The method according to claim 9, which further comprises using a purely statistical z-value to check the defined tolerance band.

11. The method according to claim 10, which further comprises determining a sample value by use of the z-value taken from a sample in order to calculate how many standard deviations of the sample value are above or below a mean, wherein, on creation of the calibration curve or the calibration table, a standard deviation of individual measuring points is also determined.

12. The method according to claim 1, which further comprises carrying out a preparation of the calibration curves and/or the calibration table with different density and viscosity standards and a direct calibration function or calibration table is obtained as a result, which sets a density error of the frequency oscillator in a functional relationship with the dynamic viscosity, wherein a density correction value K_{d} is determined or calculated from a measurement of the attenuation or a variable derived from this.

13. The method according to claim 1, wherein:
the calibration curve or the calibration table is determined with different density and viscosity standards, which sets a density error of the frequency oscillator in relation to the dynamic viscosity;
a density correction value is calculated from the attenuation or the quality;
a further density correction value is determined from the measured value using a viscometer; and
the values determined from a calibration function compares the attenuation of a natural oscillation and the further density correction values with one another.

14. The method according to claim 1, which further comprises determining a relationship between the viscosity-dependent density of the measured fluid and an amplitude and/or phase of a natural frequency of the oscillator tube.

15. The method according to claim 1, which further comprises during the course of measurement of the measured fluid with the frequency oscillator, determining a density of the measured fluid as the measured value for the relevant parameter.

16. A device for determining a filling quality of a measurement fluid flowing through an oscillator tube, the device comprising:
a frequency oscillator having said oscillator tube and functioning as a measuring unit for determining a viscosity-dependent density value of the measurement fluid flowing through said oscillator tube;
a unit for determining values of a dynamic viscosity of the measurement fluid; and
an evaluation unit for determining viscosity-dependent density values from a quality and/or an attenuation of said oscillator tube of said frequency oscillator, said evaluation unit having a calibration curve or calibration table containing or reproducing the calibration curve or the calibration table of a previously determined functional relationship between a parameter relevant for the quality or the attenuation of said frequency oscillator and the dynamic viscosity of the measurement fluid, said evaluation unit connected to said frequency oscillator and said unit for determining values of the dynamic viscosity.

17. The device according to claim 16, wherein said evaluation unit has a comparison unit for measured values or values that have been determined for the dynamic viscosity, and for the quality and/or the attenuation of said frequency oscillator.

18. The device according to claim 17, wherein said comparison unit is formed by a distance measuring unit, which determines a distance between the measured values and/or a distance of the measured values from the calibration curve or function values contained in the calibration table.

19. The device according to claim 17, further comprising a display unit connected to said comparison unit for a comparison result and/or for a degree of agreement or a distance between the values for the viscosity on the calibration curve or in the calibration table and the values obtained for the quality and/or attenuation on the calibration curve or in the calibration table.
